(19) United States
(12) Patent Application Publication
(10) Pub. No.: US 2022/0378252 A1
(43) Pub. Date: Dec. 1, 2022

(54) FOLDABLE DRAIN PAD FOR FAUCET AND DRAINING METHOD THEREOF

(71) Applicant: Xiaoyan Qian, Shenzhen (CN)

(72) Inventor: Xiaoyan Qian, Shenzhen (CN)

(21) Appl. No.: 17/742,437

(22) Filed: May 12, 2022

(30) Foreign Application Priority Data
Apr. 26, 2022 (CN) 2022104425753
Apr. 26, 2022 (CN) 2022209771705

(51) Int. Cl. A47J 47/20

(52) U.S. Cl. CPC A47J 47/20

(57) ABSTRACT

The present disclosure provides a foldable drain pad for a faucet. The back of the drain pad is provided with a bent groove, so that the drain pad can form a bottom plate and a folded plate which can be bent along the bent groove. The bottom plate is provided with a through hole and a connecting groove which is connected with the through hole, so that the faucet can enter along the path of the connecting groove and be installed at the through hole. A plurality of sealing fins are formed on the peripheral surface of the through hole on the bottom plate, and a U-shaped connecting part is arranged between two adjacent sealing fins, so that the sealing fins can wrap the pipe wall of the faucet in all directions by folding. There is a U-shaped connecting part between the sealing fins, and the joint action of the sealing fins and the U-shaped connecting part can realize the omni-directional wrapping function of the pipe wall of the faucet, so that the table top of the washstand is dry and sanitary. The present disclosure further provides a draining method of the foldable drain pad for the faucet. Accumulated water is drained in time through a repeated drainage effect.

### TECHNICAL FIELD

The present disclosure relates to a foldable drain pad for a faucet and a draining method thereof.

### BACKGROUND

The washstand is generally set against the wall, and a faucet is installed on the countertop of the washstand. In the process of washing, the water from the faucet is easy to splash and wet the countertop, which mainly shows that most of the splashed water stays near the installation seat of the faucet, causing the countertop to be wet, while toiletries, cosmetics and the like are generally placed on the countertop, and the wet countertop will obviously bring bad experience to users; in the prior art, generally, a silica gel cushion such as a drain pad and a splash pad is sleeved on the installation seat of the faucet, and the splashed water is collected on the upper surface of the cushion and flows back to the washstand, so that the washstand is kept dry and sanitary. The existing drain pad, splash pad and other products are provided with a plurality of sealing fins, which are wrapped on the pipe wall of the faucet to realize the backflow of the splashed water, while the existing sealing fins are usually independent, and there is no connection between adjacent sealing fins. When the sealing fin wraps the pipe wall of the faucet, it cannot completely wrap the pipe wall of the faucet in all directions because of the gap, which leads to water entering the lower surface of the drain pad or splash pad from the gap, that is, there is accumulated water between the drain pad or splash pad and the table top, which breeds bacteria.

### SUMMARY

In view of the shortcomings of the above problems, the present disclosure provides a foldable drain pad for a faucet and a draining method thereof.

In order to achieve the above purpose, in one aspect, the present disclosure provides a foldable drain pad for a faucet. The back of the drain pad is provided with a bent groove, so that the drain pad forms two parts: a bottom plate and a folded plate which can be bent along the bent groove; peripheral edges are formed on outer edges of the bottom plate and the folded plate, and at least one water outlet is formed on the other side of the bottom plate far from the folded plate; at least one through hole is formed on a plate surface of the bottom plate, and meanwhile a connecting groove connected with each through hole is formed on the plate surface of the bottom plate, so that the faucet enters along a path of the connecting groove and is installed at the through hole; and one or a plurality of sealing fins that can be upturned are formed on a peripheral surface of the through hole of the bottom plate, a U-shaped connecting part is arranged between two adjacent sealing fins, the U-shaped connecting part protrudes from a lower surface of the bottom plate, a plurality of protrusions are formed at a bottom of the bottom plate and/or the folded plate, on the bottom plate, heights of the protrusions decrease progressively from the bent groove to a direction that the bottom plate is away from the bent groove to form a bottom inclined surface, a thickness of the bottom plate decreases progressively from the bent groove to the direction that the bottom plate is away from the bent groove to form an upper inclined surface on an upper surface of the bottom plate, the water outlet is connected to a low position of the bottom plate, the upper surface of the bottom plate is further provided with at least one convex strip, and the upper surface of the bottom plate is also provided with at least one drain rack.

There is a U-shaped connecting part between the sealing fins, and the joint action of the sealing fins and the U-shaped connecting part can realize the omni-directional wrapping function of the faucet pipe wall, a gradient design of the height of each protrusion causes a gap to be formed between the bottom plate and a tabletop so as to facilitate ventilation and reduce a probability of retaining water at a bottom of the bottom plate, and a gradient design of the thickness of the bottom plate facilitates forming of the upper inclined surface on the upper surface of the bottom plate so as to play a role of drainage.

As a further improvement of the solution, the peripheral edges form bent openings at an end of the bent groove so as to facilitate bending and forming.

In the above technical solution, machining of the bent openings facilitates bending of a side plate along the bent groove.

As a further improvement of the solution, the through hole may be a round hole or a square hole.

In the technical solution, the through hole is designed to be round or square, so as to adapt to a common faucet with a round section or a square section.

As a further improvement of the solution, there are one through hole and one connecting groove, the path of the connecting groove is a straight line, which runs through a center of the through hole, and the straight line is orthogonal to the bent groove and runs through the folded plate at the same time.

In the technical solution, the design of the connecting groove with the straight-line path makes a product beautiful and convenient to machine.

As a further improvement of the solution, there are a plurality of convex strips, the plurality of convex strips are arranged in parallel with a uniform spacing, and lengths of the plurality of convex strips decrease progressively from a middle to two sides, so that the plurality of convex strips form an oval pattern as a whole; and there are two drain racks, and the two drain racks are detachably connected with the bottom plate.

In the above technical solution, the plurality of convex strips may form oval or other patterns, which is very beautiful, and certain drainage can be formed among the convex strips, which is also convenient for stacking dish towels on the convex strips. The drain rack can be used for hanging the dish towels or making chopsticks lean against it, which is convenient for draining water. The detachable connection is convenient for users to choose whether to configure or install the drain rack according to actual needs.

In another aspect, the present disclosure provides a draining method of a foldable drain pad for a faucet, including the following steps:

a, a process of collecting water splashing onto surrounding of the faucet through a retaining effect of a bottom plate, a folded plate and a peripheral edge;

b, a process of collecting water splashing onto a pipe wall of the faucet through a drainage effect of sealing fins and a U-shaped connecting part;

c, a process of draining water, collected by step a and step b, into a water outlet through a drainage effect of an upper inclined surface of the bottom plate and a bottom inclined surface of the bottom plate; and

d, a process of making water drained into the water outlet flow away through a basin and a drainer through a water discharging effect of the water outlet.

By means of the draining method, most of splashing water can be collected through the retaining effect of the bottom plate, the folded plate and the peripheral edge, water on the pipe wall of the faucet can be drained through the sealing fins and the U-shaped connecting part, accumulated water can be discharged in time through a secondary drainage effect of the bottom inclined surface and the upper inclined surface, it can be guaranteed that the tabletop is dry and tidy, there is no accumulated water at a bottom of the drain pad, and there is no breeding bacteria.

Compared with the prior art, the present disclosure has the beneficial effects that the sealing fins are provided with the U-shaped connecting part, and the sealing fins and the U-shaped connecting part act together to realize the omni-directional wrapping function of the faucet pipe wall; the height gradient design of the protrusions makes a gap formed between the bottom plate and the table top, which is convenient for gas circulation and reduces the possibility of water staying at the bottom of the bottom plate; and the thickness gradient design of the bottom plate facilitates the upper inclined surface of the bottom plate to play a drainage role; a plurality of convex strips can form ellipses or other patterns, which is very beautiful, and certain drainage can be formed among the convex strips, which is also convenient for folding the dish towel on the convex strips. The drain rack can be used for hanging the dish towel or leaning on the tableware, which is convenient for draining. The detachable connection is convenient for users to choose whether to configure or install the drain rack according to actual needs. By means of the draining method, most of splashing water can be collected through the retaining effect of the bottom plate, the folded plate and the peripheral edge, water on the pipe wall of the faucet can be drained through the sealing fins and the U-shaped connecting part, accumulated water can be discharged in time through a secondary drainage effect of the bottom inclined surface and the upper inclined surface, it can be guaranteed that the tabletop is dry and tidy, there is no accumulated water at a bottom of the drain pad, and there is no breeding bacteria.

### BRIEF DESCRIPTION OF DRAWINGS

FIG. 1 is a perspective view of a foldable drain pad for a faucet according to Embodiment 1;

FIG. 2 is a perspective view of a foldable drain pad for a faucet according to Embodiment 1;

FIG. 3 is a folding schematic diagram of a foldable drain pad for a faucet according to Embodiment 1;

FIG. 4 is a sectional view of FIG. 3 at the water outlet;

FIG. 5 is a schematic diagram of a foldable drain pad for a faucet according to Embodiment 1 when in use;

FIG. 6 is a perspective view of a foldable drain pad for a faucet according to Embodiment 2;

FIG. 7 is a perspective view of a foldable drain pad for a faucet according to Embodiment 2;

FIG. 8 is a schematic diagram of a foldable drain pad for a faucet according to Embodiment 2.

FIG. 9 and FIG. 10 are schematic diagrams of a product before improvement.

In the FIG. s: 1. Peripheral edge; 11. Bent opening; 2. Folded plate; 3. Bent groove; 4. Bottom plate; 41. Through hole; 42. Sealing fin; 21. U-shaped connecting part; 43. Connecting slot; 44. Convex strips; 4a, Boss; 5. Water outlet; 6. Protrusion; 7. Drain rack.

### DESCRIPTION OF EMBODIMENTS

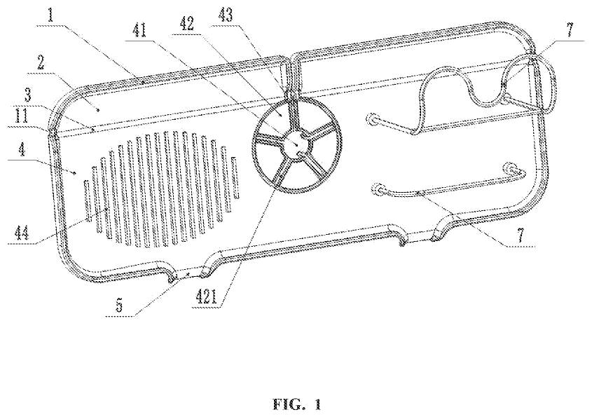

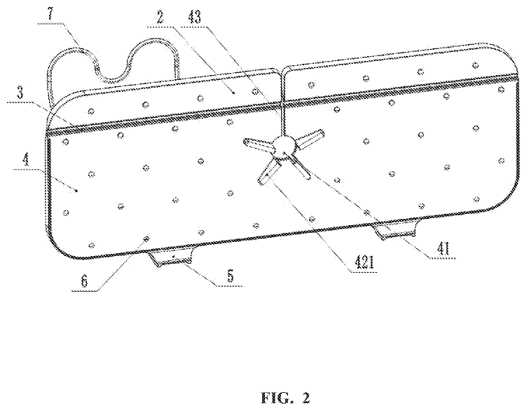

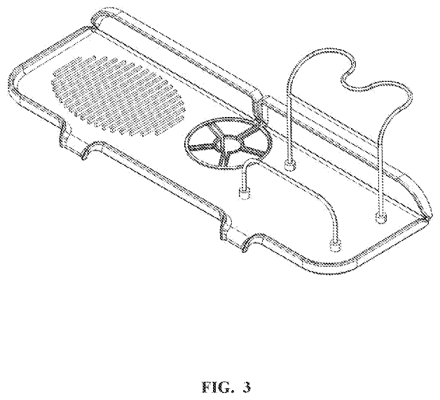

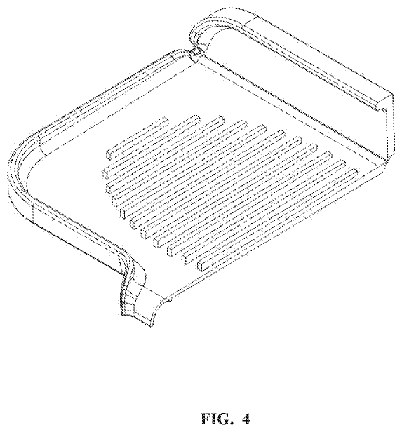

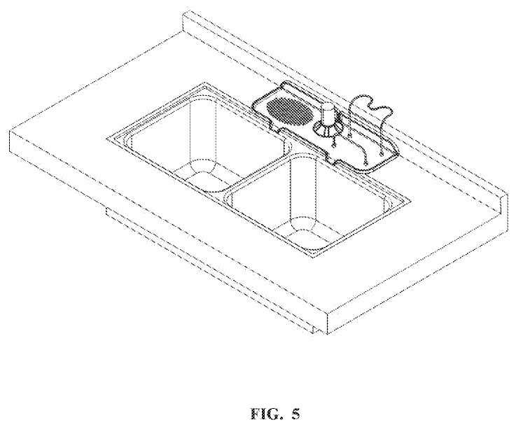

Embodiment 1: as shown in FIGS. 1-5, the foldable drain pad for a faucet of this embodiment of the present disclosure is provided with a bent groove 3 on its back, so that the drain pad forms a bottom plate 4 and a folded plate 2 which can be bent along the bent groove 3. Peripheral edges 1 are formed on the outer edges of the bottom plate 4 and the folded plate 2, and at least one water outlet 5 is formed on the other side of the bottom plate 4 away from the folded plate. Meanwhile, at least one through hole 41 is formed on the surface of the bottom plate 4. A connecting groove 43 which is connected with each through hole 41 is formed on the surface of the bottom plate 4, so that the faucet enters and is installed at the through hole 41 along the path of the connecting groove 43. A plurality of upturned sealing fins 42 are formed on the bottom plate 4, and a U-shaped connecting part 421 is arranged between two adjacent sealing fins 42, and the U-shaped connecting part 421 protrudes from the lower surface of the bottom plate 4. A plurality of protrusions 6 are formed on the bottoms of the bottom plate 4 and the folded plate 2. The height of the protrusion 6 decreases from the bent groove 3 to the direction of the bottom plate 4 away from the bent groove 3 to form a bottom inclined surface, and the thickness of the bottom plate 4 decreases from the bent groove 3 to the direction of the bottom plate 4 away from the bent groove 3 to form an upper inclined surface on the upper surface of the bottom plate 4. Two water outlets 5 are connected to the low position of the bottom plate 4, and the upper surface of the bottom plate 4 is also provided with at least one convex strip 44, and the upper surface of the bottom plate 4 is also provided with at least one drain rack 7. Wherein,

the peripheral edge 1 forms a bent opening 11 at the end of the bent groove 3 to facilitate bending and molding, and the bent opening facilitates the bending of the side plate along the bent groove; the through hole 41 can be a round hole or a square hole, and the through hole is designed to be round or square, so as to adapt to a common faucet with a round or square cross section; there are one through hole 41 and one connecting groove 43; the path of the connecting groove 43 is a straight line, which runs through the center of the through hole 41, and the straight line is orthogonal to the bent groove 3 and runs through the folded plate 2 at the same time. The design of the connecting groove of the straight line makes the product beautiful and convenient to process. There are a plurality of convex strips 44 which are arranged in parallel with the same spacing, and the lengths of the convex strips 44 decrease from the middle to two sides, so that the convex strips 44 form an oval pattern as a whole; two drain racks 7 are detachably connected with the bottom plate 4, and the convex strips can form an oval or other patterns, which is very beautiful; moreover, certain drainage can be formed among the convex strips, and it is also convenient to stack the dish towel on the convex strips; and the drain rack can be used for hanging the dish towel or as a support for tableware, which is convenient for drainage.

There is a U-shaped connecting part between the sealing fins, and the joint action of the sealing fins and the U-shaped connecting part can realize the omni-directional wrapping function of the faucet pipe wall. The height gradient design of the protrusions makes a gap between the bottom plate and the table top, which is convenient for gas circulation and reduces the possibility of water staying at the bottom of the bottom plate. The gradient design for the thickness of the bottom plate is convenient for the bottom plate to form an upper inclined surface on the upper surface to play a drainage role. A plurality of convex strips can form ellipses or other patterns, which is very beautiful, and certain drainage can be formed among the convex strips, which is also convenient for folding the dish towel on the convex strips. The drain rack can be used for hanging the dish towel or leaning on the tableware, which is convenient for draining. The detachable connection is convenient for users to choose whether to conFIG. or install the drain rack according to actual needs.

The draining method of the drain pad for the foldable faucet involved in embodiment 1 of the present disclosure comprises the following steps:

A, a process of collecting water splashed around the faucet by the containment of the bottom plate 4, the folded plate 2 and the peripheral edge 1;

B, a process of collecting the water splashed on the pipe wall of the faucet by the drainage effect of the sealing fins 42 and the U-shaped connecting part 421;

C, a process of draining the water collected in step A and step B to the water outlet 5 by the drainage effect of the upper inclined surface of the bottom plate 4 and the inclined surface of the bottom plate 4;

D, due to the drainage effect of the water outlet 5, the water drained to the water outlet 5 flowing away through the washbasin and the water drain.

The draining method can collect most of the spilled water through the containment effect of the bottom plate, the folded plate and the peripheral edge, drain the water on the pipe wall of the faucet through the sealing fins and the U-shaped connecting part, and drain the collected accumulated water in time through the secondary drainage effect of the bottom inclined surface and the upper inclined surface, so as to ensure that the tabletop is dry and tidy, and there is no water accumulation and bacteria breeding at the bottom of the drain pad.

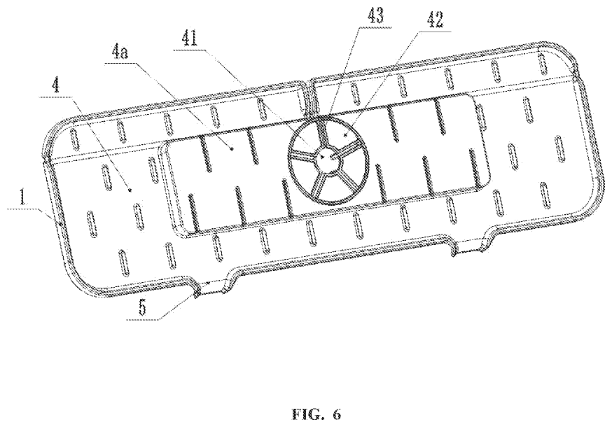

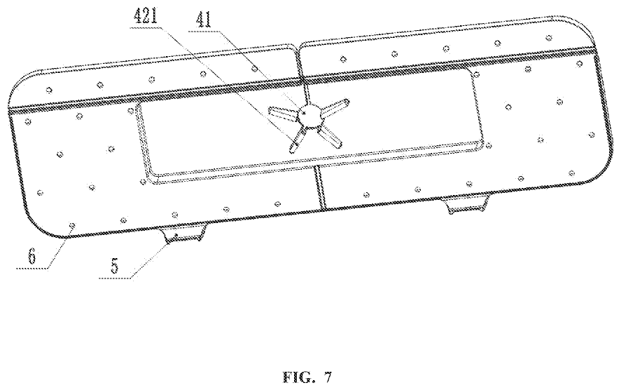

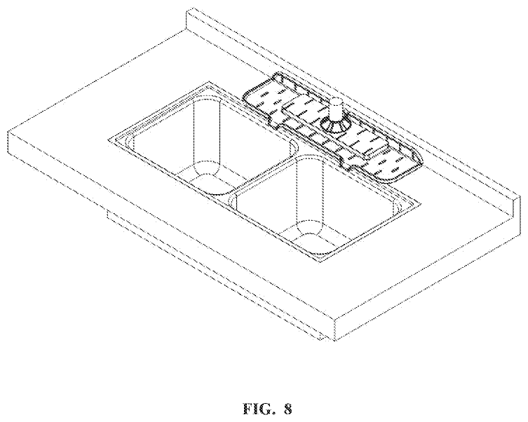

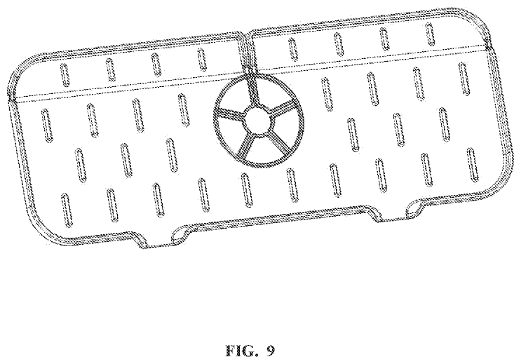

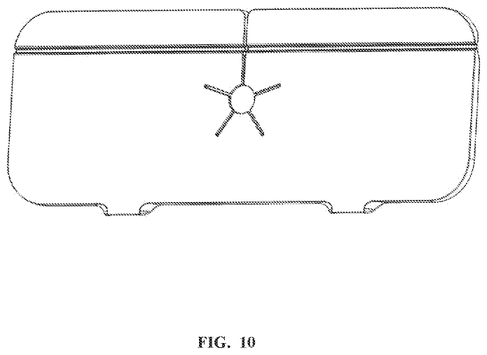

Embodiment 2: as shown in FIGS. 6-8, the foldable drain pad for a faucet of the embodiment of the present disclosure comprises a bottom plate 4, a peripheral edge 1 is formed on an outer edge of the bottom plate 4, at least one water outlet 5 is formed on the bottom plate 4, at least one through hole 41 is formed on a plate surface of the bottom plate 4, and meanwhile a connecting groove 43 connected with each through hole 41 is formed on the plate surface of the bottom plate 4, so that the faucet enters along a path of the connecting groove 43 and is installed at the through hole 41; and a plurality of sealing fins 42 are formed on a peripheral surface of the through hole 41 of the bottom plate 4, a boss 4a is formed on an upper surface of the bottom plate 4, the through hole 41 and the sealing fins 42 are both arranged on the boss 4a, a U-shaped connecting part 421 is arranged between two adjacent sealing fins 42, the U-shaped connecting part 421 protrudes from a lower surface of the boss 4a, a plurality of protrusions 6 are formed at a bottom of the bottom plate 4, heights of the protrusions 6 decrease progressively from a position away from the water outlet 5 to a direction close to the water outlet 5 so as to form a bottom inclined surface on the bottom plate 4.

The above is only the preferred embodiment of the present disclosure, and it is not used to limit the present disclosure. For those skilled in the field, the present disclosure can be modified and varied. Any modification, equivalent replacement, improvement, etc. made within the spirit and principle of the present disclosure shall be included in the scope of protection of the present disclosure.

What is claimed is:

1. A foldable drain pad for a faucet, wherein a back of the drain pad is provided with a bent groove, so that the drain pad forms two parts: a bottom plate and a folded plate which can be bent along the bent groove; peripheral edges are formed on outer edges of the bottom plate and the folded plate, and at least one water outlet is formed on the other side of the bottom plate far away from the folded plate; at least one through hole is formed on a plate surface of the bottom plate, and meanwhile a connecting groove connected with each through hole is formed on the plate surface of the bottom plate, so that the faucet enters along a path of the connecting groove and is installed at the through hole; and one or a plurality of sealing fins that can be upturned are formed on a peripheral surface of the through hole of the bottom plate, characterized in that a U-shaped connecting part is arranged between two adjacent sealing fins, the U-shaped connecting part protrudes from a lower surface of the bottom plate, a plurality of protrusions are formed at a bottom of the bottom plate and/or the folded plate, on the bottom plate, heights of the protrusions decrease progressively from the bent groove to a direction that the bottom plate is away from the bent groove to form a bottom inclined surface, a thickness of the bottom plate decreases progressively from the bent groove to the direction that the bottom plate is away from the bent groove to form an upper inclined surface on an upper surface of the bottom plate, the water outlet is connected to a low position of the bottom plate, the upper surface of the bottom plate is further provided with at least one convex strip, and the upper surface of the bottom plate is further provided with at least one drain rack.

2. The foldable drain pad for the faucet according to claim 1, characterized in that the peripheral edges form bent openings at an end of the bent groove so as to facilitate bending and forming.

3. The foldable drain pad for the faucet according to claim 1, characterized in that the through hole may be a round hole or a square hole.

4. The foldable drain pad for the faucet according to claim 1, characterized in that there are one through hole and one connecting groove, the path of the connecting groove is a straight line, which runs through a center of the through hole, and the straight line is orthogonal to the bent groove and runs through the folded plate at the same time.

5. The foldable drain pad for the faucet according to claim 1, characterized in that there are a plurality of convex strips, the plurality of convex strips are arranged in parallel with a uniform spacing, and lengths of the plurality of convex strips decrease progressively from a middle to two sides, so that the plurality of convex strips form an oval pattern as a whole; and there are two drain racks, and the two drain racks are detachably connected with the bottom plate.

6. A foldable drain pad for a faucet, comprising a bottom plate, wherein a peripheral edge is formed on an outer edge of the bottom plate, at least one water outlet is formed on the bottom plate, at least one through hole is formed on a plate surface of the bottom plate, meanwhile a connecting groove connected with each through hole is formed on the plate surface of the bottom plate, so that the faucet enters along a path of the connecting groove and is installed at the through hole; and a plurality of sealing fins are formed on a peripheral surface of the through hole of the bottom plate, characterized in that a U-shaped connecting part is arranged between two adjacent sealing fins, the U-shaped connecting part protrudes from a lower surface of the bottom plate, a plurality of protrusions are formed at a bottom of the bottom plate, heights of the protrusion decrease progressively from a position away from the water outlet to a direction close to the water outlet so as to form a bottom inclined surface on the bottom plate.

7. A foldable drain pad for a faucet, comprising a bottom plate, wherein a peripheral edge is formed on an outer edge of the bottom plate, at least one water outlet is formed on the bottom plate, at least one through hole is formed on a plate surface of the bottom plate, and meanwhile a connecting groove connected with each through hole is formed on the plate surface of the bottom plate, so that the faucet enters along a path of the connecting groove and is installed at the through hole; and a plurality of sealing fins are formed on a peripheral surface of the through hole of the bottom plate, characterized in that a boss is formed on an upper surface of the bottom plate, the through hole and the sealing fins are both arranged on the boss, a U-shaped connecting part is arranged between two adjacent sealing fins, the U-shaped connecting part protrudes from a lower surface of the boss, a plurality of protrusions are formed at a bottom of the bottom plate, heights of the protrusions decrease progressively from a position away from the water outlet to a direction close to the water outlet so as to form a bottom inclined surface on the bottom plate.

8. (canceled)
